(19) United States
(12) Patent Application Publication
(10) Pub. No.: US 2007/0002743 A1
(43) Pub. Date: Jan. 4, 2007

(54) Means and method of allocating channel bandwidth

(75) Inventor: Zhong Fan, Bristol (GB)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/414,379

(22) Filed: May 1, 2006

(30) Foreign Application Priority Data
Jul. 1, 2005 (GB) 0513520.7

(51) Int. Cl. H04J 1/16; H04Q 7/00

(52) U.S. Cl. 370/235; 370/329

(57) ABSTRACT

A wireless communications device is arranged in operation to estimate a future bandwidth requirement, compare the estimated future bandwidth requirement with the currently allocated requirement to obtain a difference value, compare that difference value with a threshold, and where the difference value exceeds the threshold, request a new bandwidth allocation in accordance with the estimated future bandwidth requirement.

The present invention relates to a method and means of bandwidth allocation. In particular, but not exclusively, it relates to the allocation of channel time for variable bit rate video using an IEEE 802.15.3 protocol.

Wireless personal area networks (WPANs) are for the purposes of this disclosure, characterised as ultra-wideband, small range networks within which to transfer large volumes of data between personal devices and any larger networks with which those devices may interface. A major potential application for such a personal network is the provision of multimedia material to one or more devices about the user, and in particular, real-time video. WPANS may also be useful for providing wireless links between devices in the home, such as a DVD player and a high definition TV.

To facilitate such applications, an ultra wide band network requires medium access control between a potentially fluid number of high data rate devices. The Institute of Electrical & Electronics Engineers (IEEE) 802.15.3 protocol is a suitable candidate for such networks.

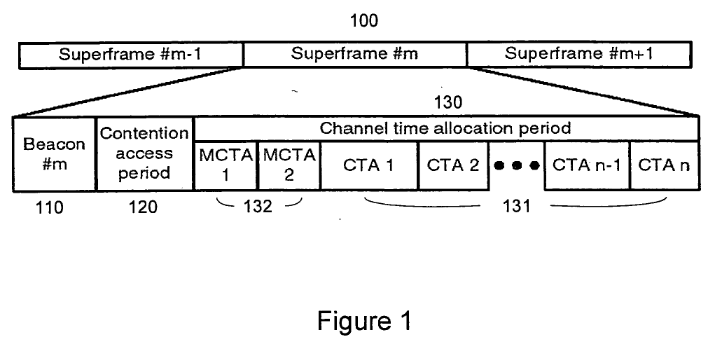

An IEEE 802.15.3 network is based on the concept of a piconet, controlled by a piconet controller (PNC). Referring now to FIG. 1, the timing of channel access in such networks is governed by so-called superframes 100. A superframe 100 consists of three parts: a beacon 110, a contention access period (CAP) 120, and a channel time allocation period (CTAP) 130. The beacon 110 is used to set the timing allocations and to communicate management information for the piconet. The contention access period is used to communicate commands and/or asynchronous data if it is present in the superframe. During the CAP, the wireless devices in the network access the channel in a distributed fashion using a Carrier Sense Multiple Access/Collision Avoidance (CSMA/CA) contention method and a backoff procedure. The channel time allocation period 130 is composed of channel time allocations (CTAs) 131, and management CTAs (MCTAs) 132. CTAs 131 are used for commands, isochronous streams and asynchronous data connections. The CTAP 130 uses a standard time division multiple access (TDMA) protocol where the wireless devices in the network have specified time windows for communication that have guaranteed a start time and duration. All the CTAs for the current superframe 100 are broadcast in the beacon 110.

For time-critical applications such as the provision of high-definition video with a smooth picture rate, it is important to have a bandwidth allocation scheme that meets the quality of service requirements of each of the applications within the WPAN.

However, IEEE 802.15.3 does not specify a bandwidth allocation scheme (in a TDMA network, equivalent to channel time allocation), but simply states that ‘in no case shall a device extend its transmissions that started during a CTA beyond the end of that CTA’. Thus, in the case of a vide stream, if there is not enough time within the CTA to complete a frame exchange sequence (e.g. short inter-frame space and acknowledgement), then the transmitting device must abort the frame. The result may be buffer overload, packet loss and choppy video.

It is expected that most multimedia content in the foreseeable future will be transmitted in the form of MPEG 2 or MPEG 4. An MPEG encoder compresses a video signal at a constant picture rate (e.g. 30 frames/sec), and generates data frames that are image dependent and thus variable. Moreover, a notional ‘unit’ of video, called a Group Of Pictures (GOP), comprises different types of frames, typically I, P and B frames, where I frames are reference frames containing a large amount of static data, and the remaining frames encode difference vectors as the successive images change. Thus a typical GOP consisting of 12 frames may have the pattern IBBPBBPBBPBB, which has a highly variable bit rate on a frame-by-frame basis. Thus, MPEG is referred to as a variable bit rate (VBR) encoding scheme.

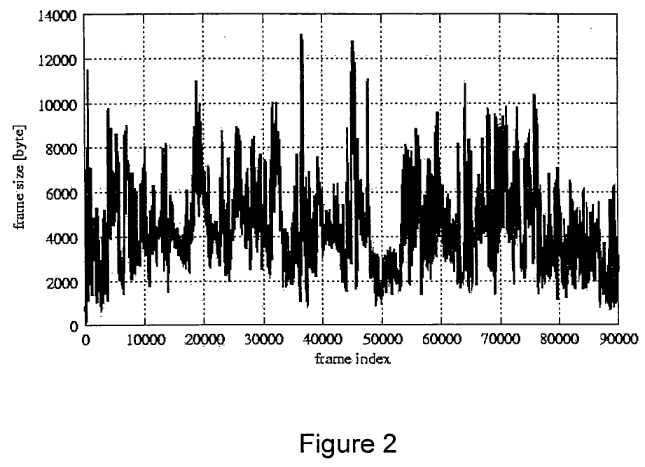

FIG. 2 is a graph illustrating the size (in bits) of successive frames in an MPEG video stream. It is well known that VBR video traffic such as that based on MPEG standards is bursty, with a high peak to mean traffic ratio, as can be seen in FIG. 2. Moreover, it is often highly correlated and has long tail distributions.

This variability in frame size is problematic for bandwidth allocation in a protocol such as IEEE 802.15.3; if bandwidth is allocated on the basis of mean data rate, then as noted previously, many frames will not successfully be transmitted in time and will be dropped, resulting in reduced quality of service. Conversely, allocating bandwidth on the basis of peak data rate resolves the problems of quality of service, but wastes valuable bandwidth.

Rhee et. al, ‘An application-aware MAC scheme for IEEE 802.15.3 high-rate WPAN’, IEEE WCNC, 2004, proposes allocating channel times according to known frame sizes for I, P and B frames. The paper suggests that a device informs the PNC of the maximum frame size in its data set, allowing the PNC to allocate the device the time allocation required to accommodate the maximum peak rate. However, for real-time applications this information is not known in advance, making the solution impractical. Similarly, it cannot be relied upon that every media source in a network will provide such information even when it may be obtainable. Moreover, as noted above, where the maximum frame size is large compared with the mean, this solution is still wasteful of bandwidth.

Thus, there appears scope to provide improve bandwidth allocation for VBR traffic in wireless networks such as WPAN.

The present invention intends to provide such an improved bandwidth allocation.

In a first aspect of the present invention, a communications device comprises prediction means arranged in operation to estimate a future bandwidth requirement, and further comprises means to transmit, in operation, a bandwidth allocation request command if the predicted future bandwidth differs from the currently available bandwidth by a threshold amount.

In a configuration of the above aspect, the prediction means of the wireless communications device comprises at least a first adaptive linear predictor.

In a configuration of the above aspect, the at least first linear predictor is a normalised linear mean square predictor.

In a configuration of the above aspect, a first adaptive linear predictor uses the size of a group of pictures in predicting the bandwidth requirement.

In a configuration of the above aspect, a first adaptive linear predictor uses only I-frame information in predicting the bandwidth requirement.

In a configuration of the above aspect, the future bandwidth requirement is estimated by predicting either an estimate of the actual bandwidth value, or an estimate of the change in bandwidth value from the current value.

In a configuration of the above aspect, the bandwidth allocation request, transmitted when the predicted future bandwidth differs from the currently available bandwidth by a threshold amount, specifies a channel time allocation period sufficient to accommodate the estimated bandwidth.

In an aspect of the present invention, a network controller comprises an admission controller arranged in operation to receive a bandwidth allocation request and, conditionally, modify a bandwidth allocation in response to said bandwidth allocation request, and a beacon construction means operable to build a beacon detailing a bandwidth allocation scheme in turn comprising said modified bandwidth allocation.

In a configuration of the above aspect, the bandwidth is allocated as channel time.

In a configuration of the above aspect, the admission controller is operable to modify the channel time allocation in response to a received request for a larger bandwidth allocation subject to any or all of the conditions that there are sufficient time units available within the channel time allocation period, and quality of service is maintained to acceptable levels in consequence for other channels with channel time allocated to them.

In a configuration of the above aspect, the admission controller is operable to allocate additional time units from free time units within the channel time allocation period, and/or time units obtained by renegotiating channel time allocations of other streams.

In an aspect of the present invention, a method of regulating channel bandwidth comprises the steps of estimating a future bandwidth requirement, comparing the estimated future bandwidth requirement with the currently allocated requirement to obtain a difference value, comparing said difference value with a threshold, and where the difference value exceeds said threshold, requesting a new bandwidth allocation in accordance with the estimated future bandwidth requirement.

In a configuration of the above aspect, the step of predicting the estimated future bandwidth requirement in turn comprises the steps of initialising the filter coefficients of a linear predictor, and updating the filter coefficients in response to successive frames of a data sequence.

In another aspect of the present invention, a method of regulating channel bandwidth comprises the steps of receiving a bandwidth allocation request, modifying a bandwidth allocation in response to said bandwidth allocation request, and building a beacon detailing a bandwidth allocation scheme that in turn comprises said bandwidth allocation.

In a configuration of the above aspect, bandwidth is allocated as channel time.

In a configuration of the above aspect, a further step comprises determining whether to modify said channel time allocation in response to whether sufficient time units are available within the channel time allocation period, and/or whether quality of service is acceptably maintained in consequence for other channels with allocated time.

In a configuration of the above aspect, the step of modifying a channel time allocation further comprises, in the case of a request for greater bandwidth, the step of allocating additional time units from free time units within the channel time allocation period, and/or time units obtained by renegotiating channel time allocations of other streams.

In an aspect of the present invention, a data carrier comprises computer implementable instructions that, when loaded into a computer, cause the computer to operate as a communications device as claimed herein.

In an aspect of the present invention, a data carrier comprises computer implementable instructions that, when loaded into a computer, cause the computer to operate as a network controller as claimed herein.

In an aspect of the present invention a data carrier comprises computer implementable instructions that, when loaded into a computer, cause the computer to perform the method carried out by a communications device in operation as claimed herein.

In an aspect of the present invention a data carrier comprising computer implementable instructions that, when loaded into a computer, cause the computer to perform the method carried out by a network controller in operation as claimed herein.

Embodiments of the present invention will now be described by way of example with reference to the accompanying drawings, in which:

FIG. 1 is a schematic diagram of a network superframe, as known in the art.

FIG. 2 is a graph illustrating the variability of MPEG traffic, plotting frame size in bytes on the y-axis against frame index on the x-axis.

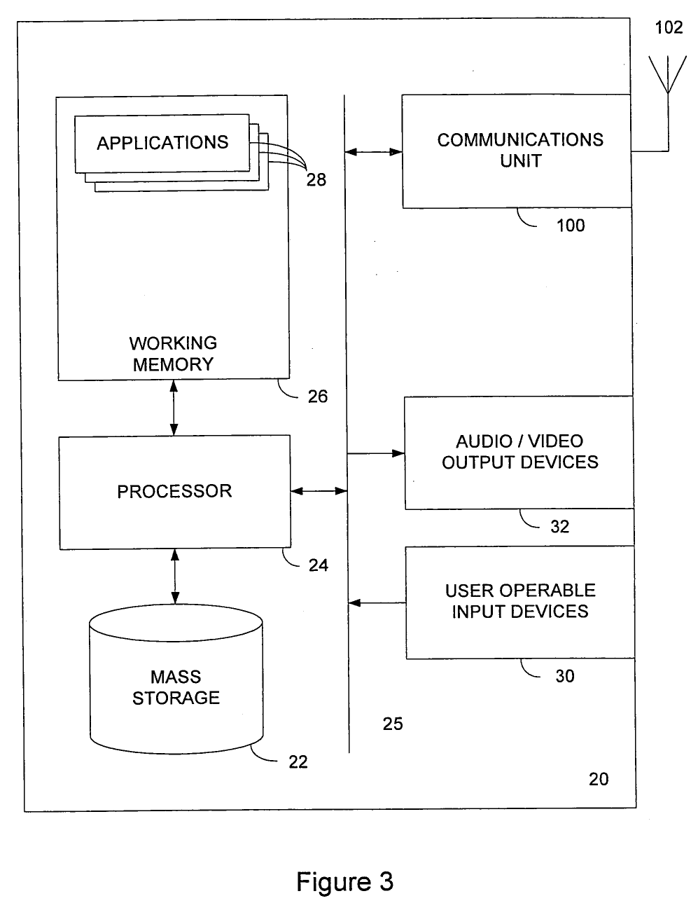

FIG. 3 is a schematic diagram of a wireless device in accordance with an embodiment of the present invention.

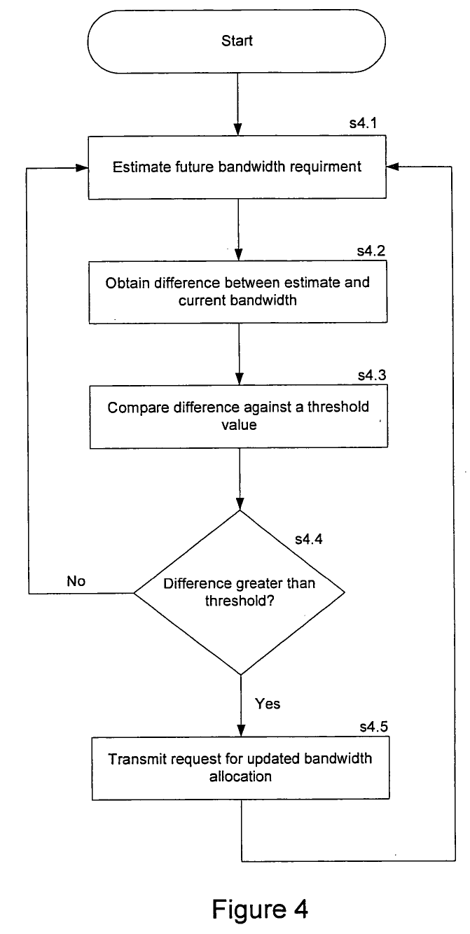

FIG. 4 is a flow diagram a of method of regulating channel bandwidth in accordance with an embodiment of the present invention.

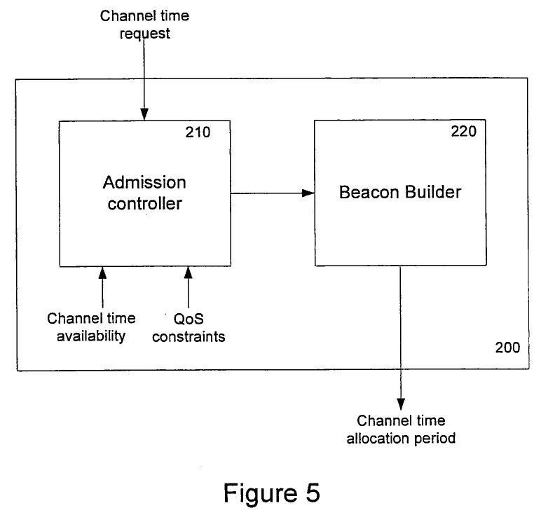

FIG. 5 is a schematic diagram of a network controller in accordance with an embodiment of the present invention.

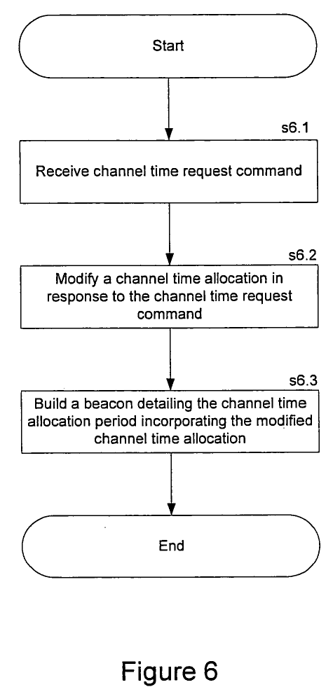

FIG. 6 is a flow diagram a of method of regulating channel bandwidth in accordance with an embodiment of the present invention.

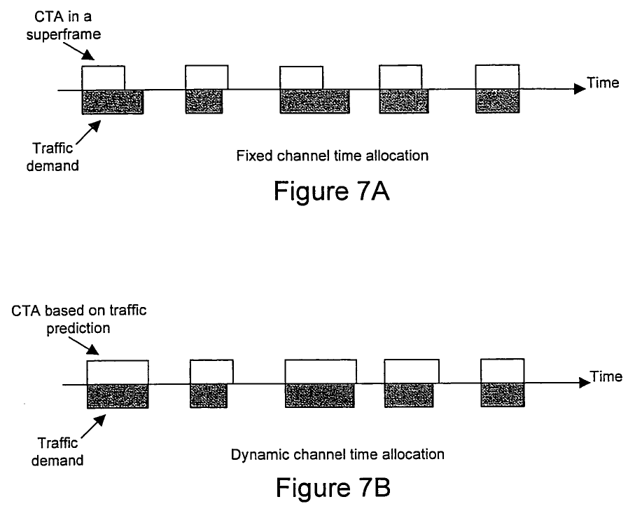

FIG. 7A is a schematic diagram illustrating a channel time allocation scheme known in the art.

FIG. 7B is a schematic diagram illustrating a channel time allocation scheme in accordance with an embodiment of the present invention.

A wireless communication system is disclosed. In the following description, a number of specific details are presented, by way of example, in order to provide a thorough understanding of embodiments of the present invention. It will be apparent, however, to a person skilled in the art that these specific details need not be employed to practice the present invention.

FIG. 3 illustrates schematically a wireless communications device 20 according to an embodiment of the present invention. The device 20 comprises a processor 24 operable to execute machine code instructions stored in a working memory 26 and/or retrievable from a mass storage device 22. By means of a general-purpose bus 25, user operable input devices 30 are in communication with the processor 24. The user operable input devices 30 comprise, in this example, a keyboard, but could include a mouse or other pointing device such as a touchpad, a contact sensitive surface on a display unit of the device, a writing tablet, speech recognition means, haptic input means, or any other means by which a user input action can be interpreted and converted into data signals.

Audio/video output devices 32 are further connected to the general-purpose bus 25, for the output of information to a user. Audio/video output devices 32 include a visual display unit, and a speaker, but can also include any other device capable of presenting information to a user.

A communications unit 100 is connected to the general-purpose bus 25, and further connected to an antenna 102. By means of the communications unit 100 and the antenna 102, the device 20 is capable of establishing wireless communication with another device. The communications unit 100 is operable to convert data passed thereto on the bus 25 to an RF signal carrier in accordance with a communications protocol previously established for use by a system in which the device 20 is appropriate for use.

In the device 20 of FIG. 2, the working memory 26 stores user applications 28 which, when executed by the processor 24, cause the establishment of a user interface to enable communication of data to and from a user. The applications 28 thus establish general purpose or specific computer implemented utilities and facilities that might habitually be used by a user.

In an embodiment of the present invention, the communications device 100 comprises means of channel time allocation responsive to traffic prediction, being operable to request greater or lesser time according to predicted need.

In an embodiment of the present invention an adaptive linear predictor (ALP) predicts the required rate of the next GOP in a VBR stream.

Defining s(n) as the rate of the n^{th} GOP in a VBR stream, then a p^{th} order, one-step ALP has the form

$${s}^{′} ( n + 1 ) = {\sum }_{l = 0}^{p - 1} w ( l ) s ( n - l ) = {W}^{T} S ( n ) ,$$

where w(l), l=0, . . . , p−1 are the filter coefficients, W=[w(0), . . . w(p−1)]^{T} and S(n)=[s(n), s(n−1), . . . , s(n−p+1)]^{T}.

The order of the predictor can be determined according to the Akaike information criterion. For MPEG, a value of p=12 is typical.

The prediction error e(n) then equals s(n)−s′(n).

In an embodiment of the present invention, the error is used to update the ALP in a linear mean square (LMS) scheme, wherein in operation the predictor
i) begins with an initial estimate of the filter coefficients W(0), and
ii) updates W(n) for each frame using
   W(n+1)=W(n)+μe(n)S(n)/∥S(n)∥²,
   Where μ is the update step size.

In an embodiment of the present invention, the LMS is a normalised LMS, which is less sensitive to step size.

Advantageously, ALPs do not require prior knowledge of the video statistics and do not assume their stationarity, making the ALP suitable for on-line and real-time applications.

Similarly advantageously, simulations show that the prediction error resembles white noise. In consequence there are no long runs of over or under estimation, so limiting the waste of bandwidth or the need for large transmission buffers, respectively.

The estimate of the rate s′(n+1) output by the ALP is passed to a comparator, in which, in operation, the absolute difference between s′(n+1) and s(n) is compared against a threshold value T.

If |s′(n+1)−s(n) |<T, then no change is requested to the channel time allocation.

However, if |s′(n+1)−s(n) |≧T, then a channel time request command is sent to the PNC, requesting a CTA commensurate with the predicted bandwidth s′(n+1).

Thus the comparator conditionally requests changes to the bandwidth allocation of the device. The value of Twill be a trade-off between the required accuracy of allocation and the overheads of messaging to facilitate allocation change. Thus, T can be selected according to preference or circumstance.

In practice, the requested CTA will also factor in overheads such as SIFS and ACKs as specified in the IEEE 802.15.3 standard. In addition, the requested CTA could also take into account possible frame fragmentation.

It will be appreciated by a person skilled in the art that s(n) may represent the change in bandwidth between successive GOPs rather than the actual bandwidth, or size, of a GOP. Potentially the change in GOP size provides a smoother sequence than the GOP size itself, resulting in improved prediction performance from the ALR. Clearly in this case the threshold will compare against the absolute predicted change directly, and the channel time request command relates to the current bandwidth plus the predicted change.

It will similarly be appreciated that more sophisticated prediction methods than ALR may be employed, for example a non-linear predictor, although usually at the cost of battery life or processing resources within the device.

It will also be appreciated that where there is a correlation between the size of the I-frame and subsequent P and B frames in a GOP, then the I-frame alone may be used as the basis for prediction, if the resulting predictions are of satisfactory accuracy. Other permutations of frame prediction will also be apparent, such as providing ALPs specific to each of the I, P and B types of frame.

Referring to FIG. 4, the corresponding method of regulating channel bandwidth from a wireless communications device comprises the steps:
s4.1 estimating a future bandwidth requirement;
s4.2 comparing the estimated future bandwidth requirement with the currently allocated requirement to obtain a difference value;
s4.3 comparing said difference value with a threshold, and;
s4.4 where the difference value exceeds said threshold,
s4.5 requesting a new channel time allocation in accordance with the estimated future bandwidth requirement.

Referring now to FIG. 5, a piconet controller 200 comprises, inter alia, an admission controller 210 and a beacon builder 220. In operation, the admission controller 210 receives a channel time request command from a device that has predicted a change in bandwidth requirement that exceeds its threshold value.

In an embodiment of the present invention, in operation the admission controller adopts the following admission policy:
i. Where the channel time request command requests to decrease its CTA, this is granted.
ii. Where the channel time request command requests to increase its CTA, the admission controller determines whether there are enough time units available within the CTAP. If there are enough, then the increase is granted.

In either case, if the decision is to grant a change, this is passed to the beacon builder 220, which builds a new beacon detailing the CTAP with the modified CTA for the requesting device.

It will be appreciated by a person skilled in the art that various admission policies are possible, based on QoS levels, equal access, priviledged access, application type etc. Thus, for example, where a channel time request command requests to increase its CTA, an example admission controller determines whether there are enough time units available within the CTAP. Where there are not, it looks to see whether any other devices on the network could forgo time units, with an acceptable loss of QoS, to reassign to the requesting device. In a further example, these considerations are responsive to application or device privilege levels.

Referring to FIG. 6, the corresponding method of regulating channel bandwidth at a network controller comprises the steps:
s6.1 receiving a channel time request command;
s6.2 modifying a channel time allocation in response to said channel time request command, and;
s6.3 building a beacon detailing a channel time allocation period that in turn comprises said channel time allocation.

Referring now to FIG. 7, the advantageous effect of predictive channel time allocation (CTA) is illustrated in comparison with fixed CTA. In FIG. 7(a), a fixed channel time allocation based on the average GOP size is repeated for every superframe despite the high variability of the traffic. In this scenario, if the time required to send an entire frame is longer than the CTA, then the remaining fragments of the GOP images have to be transmitted in the next superframe. This can cause excessive delays or packet drop due to missing a receipt deadline, and consequently deteriorate the video quality. In contrast, in FIG. 7(b), a dynamic channel time allocation scheme based on traffic prediction in accordance with the present invention is shown. Here, where a source device estimates its future frame sizes and adjust its channel time accordingly, network resources can be better matched to the traffic demand, hence facilitating the timely delivery of most frames. As a result both job failure rate and delay variation are reduced.

Whilst the embodiments of the invention have been disclosed above with reference to IEEE802.15.3 and TDMA channel time allocation, the invention is also applicable to other transmission schema and other MAC protocols.

For example, in frequency division multiple access (FDMA), and in particular orthogonal FDMA (OFDMA), the number of subcarriers or subcchannels assigned to a device is analogous to the amount of channel time allocated to a device in TDMA.

Similarly, in code division multiple access, where variable information rate coding such as orthogonal variable spreading factor (OVSF) coding is used, then the level of spreading factor assigned to a device is analogous to the amount of channel time allocated to a device in TDMA.

Thus in general the invention is applicable to any transmission scheme where bandwidth is reapportionable to one or more device within the network that is transmitting a VBR data stream. Consequently, channel time allocation requests and channel time allocations are examples of bandwidth allocation requests and bandwidth allocations in general, as envisaged within the scope of the present invention.

It will be appreciated that the one or more predictors, the comparator and the channel request generator within the communication device may be implemented separately or together in any suitably operable combination.

Similarly, it will be appreciated that the admission controller and beacon builder may be implemented separately or together in any suitably operable combination.

Thus, it will be clear to a person skilled in the art that embodiments of the present invention may be implemented in any suitable manner to provide suitable apparatus or operation; Thus, for example, a communication device may consist of a single discrete entity, multiple entities added to a conventional host device such as a computer, or may be formed by adapting existing parts of a conventional host device such as a computer. For example, communication unit 100 may be a PCMCIA card. Alternatively, a combination of additional and adapted entities may be envisaged. For example, the predictor or comparator may be implemented within the communication unit 100, or wholly or in part by software in working memory 26 run by processor 24 of the base station. Thus adapting existing parts of a conventional device may comprise for example reprogramming of one or more processors therein. As such the required adaptation may be implemented in the form of a computer program product comprising processor-implementable instructions stored on a storage medium, such as a floppy disk, hard disk, PROM, RAM or any combination of these or other storage media or signals.

1. A wireless communications device, comprising prediction means arranged in operation to estimate a future bandwidth requirement, and further comprising a request means arranged in operation to transmit a bandwidth allocation request command, if the estimated future bandwidth differs from the currently available bandwidth by a threshold amount.

2. A wireless communications device according to claim 1 wherein the prediction means comprises at least a first adaptive linear predictor.

3. A wireless communications device according to claim 2 wherein the or each adaptive linear predictor is a normalised adaptive linear mean square predictor.

4. A wireless communications device according to claim 2 wherein said first adaptive linear predictor uses group-of-pictures information to predict the bandwidth requirement.

5. A wireless communications device according to claim 2 wherein said first adaptive linear predictor uses only I-frame information to predict the bandwidth requirement.

6. A wireless communications device according to claim 1, wherein the prediction means is arranged in operation to predict a future bandwidth requirement based upon any one of;
i. an estimate of the actual bandwidth value, and
ii. an estimate of the change in bandwidth value from the current value.

7. A wireless communications device according to claim 1 wherein the bandwidth allocation request specifies a channel time allocation period sufficient to accommodate the estimated bandwidth.

8. A network controller comprising an admission controller operable to receive a bandwidth allocation request command, and modify a bandwidth allocation in response to said bandwidth allocation request command, and a beacon construction means operable to build a beacon detailing a bandwidth allocation scheme in turn comprising said modified bandwidth allocation.

9. A network controller according to claim 8 wherein the bandwidth allocation is channel time allocation.

10. A network controller according to claim 9 wherein the admission controller is operable to modify the channel time allocation in response to a received request for a larger channel time allocation subject to any or all of the following:
i. there are sufficient time units available within the channel time allocation period, and
ii. quality of service is maintained to acceptable levels in consequence for other channels with allocated time.

11. A network controller according to claim 9 wherein the admission controller is operable to allocate additional time units from any or all of the following:
i. free time units within the channel time allocation period, and
ii. time units obtained by renegotiating channel time allocations of other streams.

12. A method of allocating channel bandwidth comprising the steps of estimating a future bandwidth requirement;
comparing the estimated future bandwidth requirement with the currently allocated requirement to obtain a difference value;
comparing said difference value with a threshold, and
where the difference value exceeds said threshold, requesting a new bandwidth allocation in accordance with the estimated future bandwidth requirement.

13. A method of allocating channel bandwidth according to claim 12 wherein the step of predicting the estimated future bandwidth requirement in turn comprises the steps of
initialising the filter coefficients of a linear predictor, and;
updating the filter coefficients in response to successive frames of a data sequence.

14. A method of allocating channel bandwidth comprises the steps of
receiving a bandwidth allocation request;
modifying a bandwidth allocation in response to said bandwidth allocation request, and;
building a beacon detailing a bandwidth allocation scheme that in turn comprises said bandwidth allocation.

15. A method of allocating channel bandwidth in accordance with claim 14 further comprising, in the case where bandwidth is allocated by channel time, the step of determining whether to modify said channel time allocation in response to any or all of the following factors:
i. sufficient time units are available within the channel time allocation period, and
ii. quality of service is acceptably maintained in consequence for other channels with allocated time.

16. A method of allocating channel bandwidth in accordance with claim 15 wherein the step of modifying a channel time allocation further comprises, in the case of a request for greater bandwidth, the step of allocating additional time units from any or all of the following:
i. free time units within the channel time allocation period, and
ii. time units obtained by renegotiating channel time allocations of other streams.

17. A data carrier comprising computer readable instructions that, when loaded into a computer, cause the computer to operate as a communications device in accordance with claim 1.

18. A data carrier comprising computer readable instructions that, when loaded into a computer, cause the computer to operate as a network controller in accordance with claim 8.

19. A data carrier comprising computer readable instructions that, when loaded into a computer, cause the computer to perform the method of claim 12.

20. A data carrier comprising computer readable instructions that, when loaded into a computer, cause the computer to perform the method of claim 14.
